(19) United States
(12) Patent Application Publication
(10) Pub. No.: US 2008/0248173 A1
(43) Pub. Date: Oct. 9, 2008

(54) Microwave Cooking Container With Sequential Venting Arrangement

(76) Inventor: Gary L. Hopkins Sr., Scottsburg, IN (US)

Correspondence Address: David W Carrithers;Carrithers Law Office, PLLC, One Paragon Centre, 6060 Dutchman's Lane, Suite 140, Louisville, KY, 40205, US

(21) Appl. No.: 10/578,936

(22) PCT Filed: May 12, 2004
(86) PCT No.: PCT/US04/14907

§ 371 Date: Apr. 7, 2006

Related U.S. Application Data
(60) Provisional application No. 60/509,320, filed on Oct. 7, 2003.

(51) Int. Cl. B65D 51/16; H05B 6/80; A23L 1/01; A23L 1/025

(52) U.S. Cl. 426/243; 219/735; 220/203.01; 426/113

(57) ABSTRACT

A device to improve microwave cooking is described. The device (10) comprises a plurality of containers (12, 22) that include a venting mechanism (15, 25) on each container (12, 22). On of the containers (12) defines a first volume (14) for holding food. Another container (22) defines a second volume (24) and is operatively coupled to the first container (12). During microwaving of the food, steam is released into the first volume (14) defined by one of the containers (12). Pressure builds up creating a first pressure treatment for the food until the venting mechanism (15) is activated. Steam exits the first volume (14) through the venting mechanism (15) and enters the second volume (24). Again, pressure builds up to create a second pressure treatment for the food until the venting mechanism (25) for the container (22) is activated.

### CROSS-REFERENCE TO RELATED APPLICATION

This application claims the benefit of U.S. Provisional Application No. 60/509,320 filed Oct. 7, 2003, which is incorporated herein by reference.

### BACKGROUND OF THE INVENTION

The present invention relates to the field of cooking devices, and, more particularly, to cooking containers for use in a microwave oven for cooking meats, vegetables, and other food products.

Consumers often prefer to cook food in a microwave oven rather than conventional ovens because of the reduced cooking time required to heat foods in a microwave oven. Consumers also want to be provided with the opportunity to cook pre-packaged food products in the package in which they were purchased without the hassle of transferring the food from one container to the next.

Unfortunately, foods cooked in a microwave oven tend to be tough and/or dry in texture and consistency, rather than tender and moist. When liquid is added to the food in an attempt to retain moisture, the food can become soggy and undesirable. In addition, microwave ovens do not evenly distribute heat to the product being cooked. This results in a cooked food product that may be very hot in one area, but cold in another area. Because of these problems, many people consider microwave cooking to be problematic and generally undesirable.

One method for improving the texture and consistency of food cooked in a microwave oven is to use steam generated by the heated food product to assist in cooking the food. Cooking with steam not only provides moisture for the food being cooked, but also results in more consistent heating throughout the food product.

Specifically, a container using the steam generated by the heated food product to assist in cooking the food takes advantage of the ideal gas law, a distillation of several kinetic theories including Boyle's Law and Gay-Lussac's Law. More specifically, such containers take advantage of the proportional relationship between pressure and temperature when volume and number of gas molecules remain constant. This proportional relationship can be expressed as a mathematical equation, (P₂/P₁)=(T₂/T₁), where P₁ is the initial pressure, P₂ is the final pressure, T₁ is the initial temperature, and T₂ is the final temperature. Accordingly, any increase in pressure will result in a proportional increase in temperature that would not occur at ambient pressures. For example, if the pressure was to increases 1.2 fold (e.g., from 1 to 1.2 atmospheres), the temperature would also increase 1.2 fold (e.g., from 275 K to 330 K, which is an increase from 35° F. to 134° F.).

In order to steam cook a food product in a microwave oven, the steam must be retained within a cooking container; accordingly, the container must be at least partially sealed. When a sealed container is used to heat a food product contained therein, pressure rapidly builds as steam is generated from the heated food product. As heating continues, this pressure will continue to escalate until the container ruptures in some fashion, thereby relieving the pressure.

This relief often comes in the form of an explosion forcing an opening of the container and resulting in food being ejected therefrom. Not only does such an explosion create a mess, but it also undermines the attempt to use steam to cook the food product because the explosion causes a rapid release of the collected steam from the no longer sealed cooking environment. To avoid this problem, venting mechanisms may be provided to allow for controlled release of pressure and steam from the container. When such venting occurs, the enhanced heating environment created by the heightened pressure and contained steam is destroyed.

When preparing certain food products, this single treatment of pressure is beneficial to the cooking process, but is difficulties remain. For example, when preparing a cup or bowl of frozen soup using a single treatment of pressure, a lengthy cooking time is required to ensure that the center of the frozen bowl of soup is sufficiently heated. However, if the frozen soup is subjected to multiple treatments of pressure, the soup is cooked more evenly and the cooking time is reduced.

It is therefore the paramount object of the present invention to provide a microwave cooking container with a sequential venting arrangement that allows food product to be subjected to multiple pressure treatments.

This and other objects and advantages of the present invention will become apparent upon a reading of the following description.

### DESCRIPTION OF THE DRAWINGS

FIG. 1 is an exploded perspective view of a microwave cooking container with a sequential venting arrangement made in accordance with the present invention.

FIG. 2 is exploded perspective view of an alternative microwave cooking container with a sequential venting arrangement made in accordance with the present invention.

FIG. 3 is a perspective view of another alternative microwave cooking container with a sequential venting arrangement made in accordance with the present invention.

FIG. 4 is a perspective view of yet another alternative microwave cooking container with a sequential venting arrangement made in accordance with the present invention.

FIG. 5A is a perspective view of still another alternative microwave cooking container with a sequential venting arrangement made in accordance with the present invention.

FIG. 5B is a perspective view of still another alternative microwave cooking container with a sequential venting arrangement made in accordance with the present invention.

### DETAILED DESCRIPTION OF TUE INVENTION

The present invention is a microwave cooking container with a sequential venting arrangement that allows food product to be subjected to multiple pressure treatments during preparation. The structural features of the container of the present invention define an initial volume, holding food product, and at least one additional volume holding the initial volume. Additionally, there is a venting mechanism associated with each volume. It is not important which type of venting mechanism is used as long as it allows for a controlled release of pressure and steam from the volume after a desired pressure has been reached. For example, the venting mechanism may be a complex valve or a simple pin hole or a weakened portion in a seal enclosing the volume.

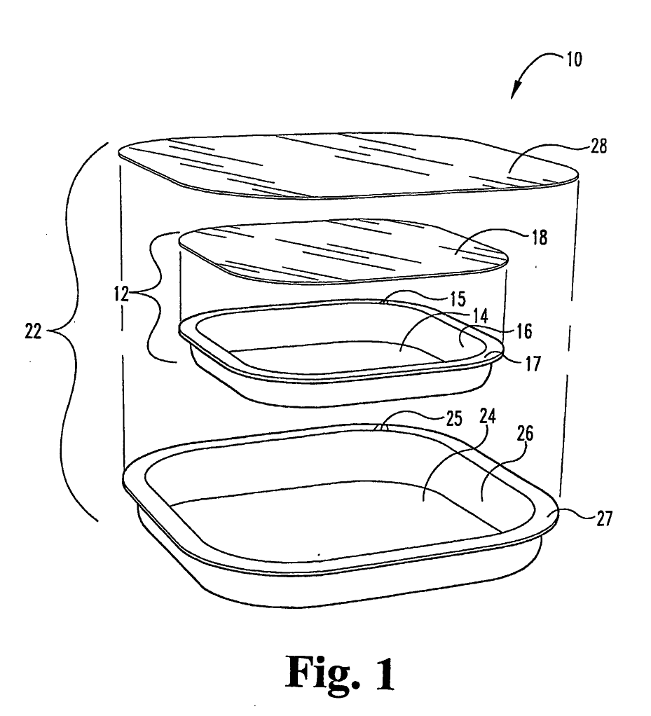

In the embodiment of the present invention depicted in FIG. 1, the initial volume 14 is defined by a first receptacle 12 while an additional volume 24 is defined by a second receptacle 22, the first receptacle 12 being held within the second receptacle 22. The first receptacle 12 includes a base 16, a cover 18 sealed to a peripheral edge 17 of the base 16, thereby enclosing the initial volume 14, and a venting mechanism 15. Similarly, the second receptacle 22 includes a base 26, a cover 28 sealed to a peripheral edge 27 of the base 26, thereby enclosing the additional volume 24, and a venting mechanism 25.

The container 10 of the present invention works in the following manner. When the container 10 is heated, pressure rapidly builds in the initial volume 14 as steam is generated from the heated food product. As heating continues, the pressure continues to build until the venting mechanism 15 associated with the initial volume 14 allows for a controlled release of pressure and steam. The steam is released from the initial volume 14 into the additional volume 24. As heating continues, the steam again causes pressure to build, this time within the additional volume 24, until controlled venting at the venting assembly 25 associated with the additional volume 24 occurs. Of course, the container may include subsequent volumes having associated venting mechanisms, allowing for subsequent pressure treatments.

The sequential venting of the container of the present invention results in the food product being subjected to an initial pressure treatment, followed by a drop in pressure before being subjected to one or more subsequent pressure treatments. Such sequential pressure treatments reduce the cooking time of food products, provide food products which are more evenly cooked, and result in prepared food products of a desired texture and consistency.

Of course, the container of the present invention may take various forms as long as the structural features enclose multiple volumes, as described above, and each volume has a venting mechanism associated therewith such that, when heated, food product is subjected to multiple treatments of pressure.

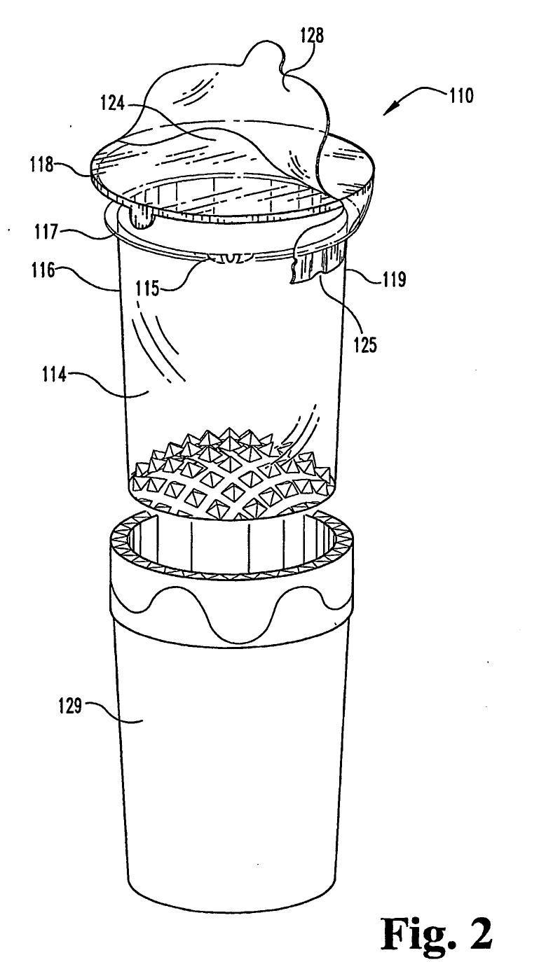

For example, FIG. 2 depicts an alternative embodiment of the present invention. In the container 110 depicted in FIG. 2, the initial volume 114 is defined by a cup 116 and a first cover 118 sealed to a circumferential edge 117 of the cup 116. The additional volume 124 is defined by the cup 116 and a second cover 128, which extends over the first cover 118 and is sealed to an external surface 119 of the cup 116. There is a venting mechanism 115 associated with the initial volume 114 and a venting mechanism 125 associated with the additional volume 124, which comprises a weakened portion in the seal between the cover 128 and the external surface 119 of the cup 116. The embodiment of the container 110 depicted in FIG. 2 works in the same manner as described above with reference to FIG. 1.

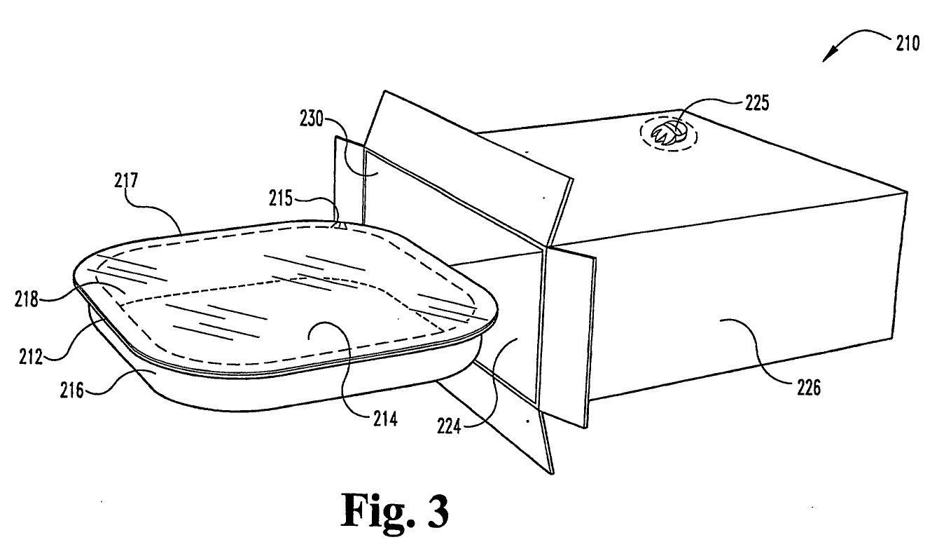

An additional alternative embodiment of the present invention is depicted in FIG. 3. In this embodiment of the container 210, the initial volume 214 is defined by a receptacle 212 including a base 216 and a cover 218 sealed to a peripheral edge 217 of the base 216 while the additional volume 224 is defined by a box 226 with an opening 230 for receiving the receptacle 212, which is thereafter sealed to enclose the additional volume 224. A venting mechanism 215, 225 is associated with both the initial volume 214 and the additional volume 224.

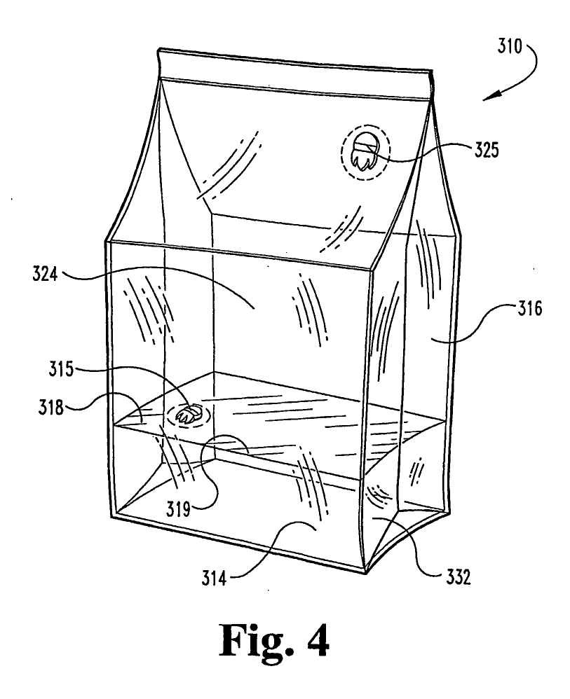

FIG. 4 depicts yet another embodiment of the present invention. In the embodiment of the container 310 depicted in FIG. 4, the initial volume 314 is defined by a lower portion 332 of a cooking bag 316 and a cover 318 sealed to an internal surface 319 of the cooking bag 316. The additional volume 324 is defined by the cooking bag 316 itself, which is sealed to contain the additional volume 324. A venting mechanism 315, 325 is associated with both the initial volume 314 and the additional volume 324.

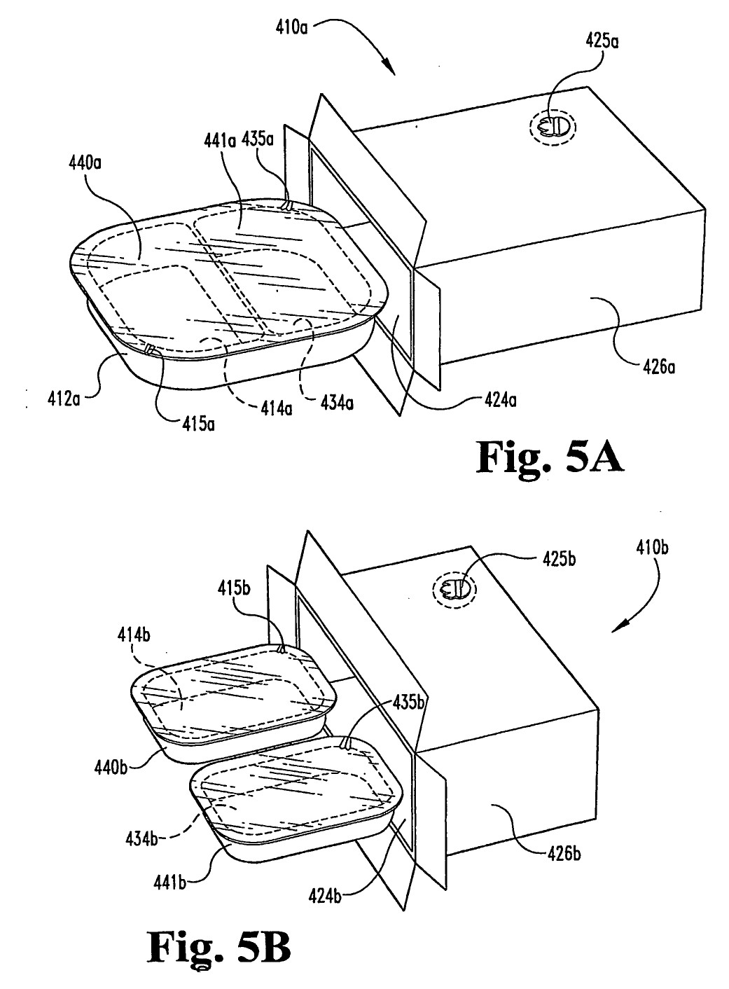

Still additional embodiments of the present invention are depicted in FIGS. 5A and 5B. In these embodiments of the container 410a, 410b there are actually two initial volumes. In the embodiment shown in FIG. 5A the container 410a includes a receptacle 412a having two compartments 440a, 441a, each with an associated venting mechanism 415a, 435a and each enclosing an initial volume 414a, 434a. The receptacle 412a is placed in a sealed box 426a defining the additional volume 424a and having a venting mechanism 425a associated therewith. As an alternative to a single receptacle having multiple compartment, separate receptacles could be provided. For example, in the embodiment of the container shown in FIG. 5B the container 410b includes a first receptacle 440b and a second receptacle 441b, each with an associated venting mechanism 415b, 435b and each enclosing an initial volume 414b, 434b. The receptacles 440b, 441b are placed in a sealed box 426b defining the additional volume 424b and having a venting mechanism 425b associated therewith. The embodiments of the container 410a, 410b depicted in FIGS. 5A and 5B work in a the same manner as those described above. When the container 410a, 410b is heated, pressure builds in the initial volumes 440a, 441a, 440b, 441b, which vent independently, releasing steam into the additional volume 424a, 424b where pressure again build, subjecting the contents of each initial volume to a second pressure treatment.

Of course, the embodiments depicted in the Figures are merely exemplary and it is contemplated that containers having a variety of structural features could be used without departing from the spirit and scope of the present invention as long as the structural features enclose at least one initial volume and at least one additional volume, holding the at least one initial volume, and each volume has a venting mechanism associated therewith.

Of course, the container of the present invention may include a variety of additional refinements. For example, in the case of the embodiment depicted in FIG. 2, the container 110 may include an insulating sleeve 129 for protecting a user and maintaining the temperature of the food product during consumption. This is but one example of a refinement that may be made to the present invention to enhance its desirability.

It will be obvious to those skilled in the art that other modifications may be made to the invention described herein without departing from the spirit and scope of the present invention.

1. A microwave cooking device comprising:
at least one first container defining at least one first volume for holding a food product, the container including at least one venting mechanism; and
a second container operatively coupled to the at least one first container, wherein the second container defines a second volume, the second container including at least one venting mechanism;
wherein steam created by the cooking of the food product in the at least one first container creates a first pressure treatment for the food product before venting into the second volume defined by the second container, wherein the second volume creates a second pressure treatment for the food product as a result of steam venting from the first container into the second container.

2. The device of claim 1, wherein the at least one first container is a first receptacle.

3. The device of claim 2, wherein the second container is a second receptacle.

4. The device of claim 2, the first receptacle further including a peripheral edge.

5. The device of claim 4, wherein the at least one first volume is defined by sealing a cover to the peripheral edge of the first receptacle.

6. The device of claim 2, wherein the second container encloses the first receptacle.

7. The device of claim 3, wherein the second receptacle encloses the first container.

8. The device of claim 1, wherein the at least one first container is a cup having an opening.

9. The device of claim 8, wherein the at least one first volume is defined by the cup and a cover sealed over the opening.

10. The device of claim 9, wherein the second container is an additional cover sealed over the opening of the cup.

11. The device of claim 1, wherein the second container is a box.

12. The device of claim 1, wherein the second container encloses the at least one first container.

13. The device of claim 1, wherein the at least one first container is a lower sealed portion of a cooking bag.

14. The device of claim 1, wherein the second container is a cooking bag.

15. The device of claim 1, having a plurality of first containers.

16. The device of claim 15, wherein the second container encloses all of the first containers.

17. The device of claim 1, wherein the at least one first container defines a plurality of separate volumes.

18. The device of claim 17, wherein the at least one first container is enclosed within the second container.

19. The device of claim 1, further including an insulating container.

20. A method for improving microwave cooking comprising:
providing a first container defining a first volume for holding food including at least one venting mechanism for enabling steam to exit the container;
providing a second container defining a second volume including at least one venting mechanism for enabling steam to exit the container; and
arranging the first container and the second container to allow steam that escapes the first volume to enter the second volume.
